(19) United States
(12) Patent Application Publication
(10) Pub. No.: US 2020/0249077 A1
(43) Pub. Date: Aug. 6, 2020

(54) METHOD AND SYSTEM FOR MEASURING ROTATION ANGLE AND TORSIONAL VIBRATION OF A ROTATING BODY BY WAY OF MODAL INTERFERENCE

(71) Applicant: Prime Photonics, LC, Blacksburg, VA (US)

(72) Inventor: Paul Samuel Zerwekh, Shawsville, VA (US)

(21) Appl. No.: 16/855,145

(22) Filed: Apr. 22, 2020

Related U.S. Application Data
(63) Continuation-in-part of application No. 16/262,566, filed on Jan. 30, 2019.
Application No. 16/262,566 is a continuation-in-part of application No. 16/047,385, filed on Jul. 27, 2018.
(60) Provisional application No. 62/538,529, filed on Jul. 28, 2017.

(51) Int. Cl. G01H 9/00; G01L 3/08; G01P 3/36; G01P 13/00

(52) U.S. Cl. CPC G01H 9/004; G01P 13/00; G01P 3/36; G01L 3/08

(57) ABSTRACT

The present disclosure relates to characterization of torque and torsional vibration in rotating bodies. More specifically, this invention enables high-fidelity, high-speed characterization of the rotary motion of a body without the requirement for surface modification. This invention relies on the inherent optical properties of the surface of the rotating body to determine the degree to which a rotating body vibrates, twists, or is otherwise translated. The system makes use of interference between propagation modes in a multi-mode optical fiber. A portion of the light reflected from the rotating body is captured by one or more multi-mode optical fiber(s) and guided to an optical detector. Rays entering the receiver fiber at different angles form different propagation modes in the fiber, and as such travel different distances. As the body rotates, the fraction of the reflected light that enters any given mode changes.

### CROSS-REFERENCE TO RELATED APPLICATIONS

This application is a Continuation-in-Part application of U.S. patent application Ser. No. 16/262,566 (“the '566 Application”), filed Jan. 30, 2019, which '566 Application is a Continuation-in-Part application of U.S. patent application Ser. No. 16/047,385 (“the '385 Application”), filed Jul. 27, 2018, which '385 Application claims priority to and the benefit of the filing date of U.S. Provisional Application No. 62/538,529, filed Jul. 28, 2017. The disclosures of these applications are hereby incorporated by reference herein in their entireties.

### BACKGROUND OF THE INVENTION

### Field of the Invention

The present disclosure relates to characterization of torque and torsional vibration in rotating bodies. More specifically, embodiments of this disclosure provide systems and methods which enable high-fidelity, high-speed characterization of the rotary motion of a body without the requirement for surface modification. In embodiments, the systems and methods rely on the inherent optical properties of the surface of the rotating body to determine the degree to which a rotating body vibrates, twists, or is otherwise translated.

### Description of Related Art

In addition to monitoring the performance of both motors and associated loads, accurate characterization of shaft torque and vibration provides critical information about fault conditions that can ultimately lead to catastrophic component failure. Measuring the torque applied to a shaft is conventionally managed through one of two general techniques; application of a physical sensor to the shaft, or through a non-contact optical technique.

Most existing methods for torque measurement typically function through direct contact with the shaft—most often through attachment of strain gages to the shaft. Application of torque to a shaft produces strain within the body of the shaft, acting along orthogonal, helical lines. Usually, strain gages are mounted to the shaft along the orthogonal, helical lines, and the local strain monitored.

The use of strain gages to measure torque is widespread and effective. While the techniques are sound and accurate, strain gage techniques suffer from difficulties in implementation. Physical application of the strain gage to the shaft requires surface treatment and epoxy selection. Reading the strain from a gage requires application of electrical power and detection in changes in electrical properties, necessitating complicated slipring attachments to provide signal feedthroughs.

Most non-contact optical methods require imparting a contrast pattern to the surface of the shaft. Whether through a laser etched blaze pattern, painted features, or the application of zebra tape, these methods require modifications to the shaft, and do not lend themselves to retrofit applications where shaft modifications are unacceptable. Furthermore, non-contact techniques are usually limited in frequency response, due to the physical resolution of the applied contract features. Most of these techniques are thus unable to capture information about higher frequency shaft vibrations that can cause ultimate failure in rotating mechanical systems.

Another technique involves measuring the Doppler shift of a laser focused onto the surface of the rotating body (U.S. Pat. No. 4,525,068). In laser doppler measurements, the photons incident on the rotating surface are frequency shifted due to the motion of the body relative to the direction of propagation of the laser. This technique allows for non-contact measurement of the twist on the rotating body, but requires sophisticated optical pathways and filtering, and can suffer signal loss due to anomalous features on the rotating surface.

The technique presented here does not directly measure torque, but rather measures the torsion angle on the shaft. Indirect torque measurements through torsion angle are a standard practice, and are commonly used to enable torque measurements with strain gages. The system described here measures the average twist along the length of the shaft between the probes.

In the range of elastic strain, the relation between torsion angle ϕ and torque M can be expressed as

$$ϕ = \frac{M \cdot I}{G \cdot {I}_{P}}$$

where I is the length of the torsional sector G is the sheer modulus of the shaft, and I_{P} is the polar moment of inertia for the shaft. The geometry of the shaft—whether hollow or solid—is accounted for in the moment of inertia portion of the equation.

Examples of efforts in this area include those described in U.S. Pat. Nos. 7,784,364; 6,759,648; 6,587,221; 6,450,044; 5,493,921; 5,182,953; 5,001,937; 4,525,068; 3,938,890; U.S. Patent Application Publication No. 20030015590; and NASA Technical Memorandum 82914 (Langley Research Center, Hampton, Va., August 1982). Yet, as with any art, there remains a need for improvements.

### SUMMARY OF THE INVENTION

Embodiments of the invention provide a method to detect the rotary motion of a body using a non-contact technique. Using at least one probe, the local modal interference pattern resulting from the reflection of the illuminating light by the surface of the rotating body is compared to a previously recorded pattern containing a normalized record of that modal interference pattern. The instantaneous modal interference between the probe and the body result in a fingerprint that represents the angular position of the shaft in time. Comparison of the instantaneous position of features in the fingerprint pattern with that of the previously recorded pattern provides a measure of the motion of the body. Using a single two fiber probe, the method enables determination of the angular speed of the body, as well as the frequency of angular vibration of the rotating body. The addition of at least one more probe reduces the sensitivity of the method to vibration, and enables characterization of the twist on the body. Given the shape and materials of the rotating body, it is possible to calculate the torque applied to the body, as described in the background section.

Other aspects of the invention include:

Aspect 1. A method for the characterization of motion of a rotating body comprising measuring at least one modal interference pattern of light reflected from a surface of a rotating body at two or more points in time, and comparing at least a portion of the measured modal interference patterns to determine a change in motion of the rotating body between those two points in time.

Aspect 2. The method of Aspect 1 wherein only a single measurement point on the body is used to determine the rotation speed of the rotating body.

Aspect 3. The method of Aspect 1 or 2 wherein a single measurement point on the body is used to determine the amplitude and/or frequency of angular vibration of the body.

Aspect 4. The method of any of Aspects 1-3 wherein multiple measurement points on the rotating body are used to determine the twist on the body.

Aspect 5. The method of any of Aspects 1-4 wherein multiple measurement points on the body are used to determine the twist on the body in order to calculate any torque applied to the body.

Aspect 6. The method of any of Aspects 1-5 wherein multiple measurement points on the body are used to determine motion on the body that is coherent between multiple measurement points in order to mitigate effects of vibration of the body that is not angular.

Aspect 7. The method of any of Aspects 1-6 wherein multiple measurement points on the body are used to determine motion on the body that is axial in nature.

Aspect 8. A method for the characterization of motion of a rotating body, comprising using at least one optical probe, measuring at least one modal interference pattern resulting from reflection of illuminating light by a surface of a rotating body to provide an initial modal interference pattern therefrom, using at least one optical probe, measuring at least one operational modal interference pattern resulting from reflection of illuminating light by the surface of the rotating body, and comparing the operational modal interference pattern to the initial modal interference pattern using a correlation function, thereby determining a phase difference between the operational modal interference pattern and the initial modal interference pattern to provide a measure of any twist of the rotating body with time.

Aspect 9. The method of any of Aspects 1-8, wherein the modal interference pattern and/or the operational modal interference pattern is measured using two optical probes.

Aspect 10. The method of any of Aspects 1-9, which is a non-contact measuring technique for measuring one or more of vibrations, twisting, torsion angle, and/or other translation of the rotating body.

Aspect 11. The method of Aspect 10 wherein the vibrations, twisting, torsion angle, and/or other translation have a frequency in the range of 1-5 kHz, in the range of 5-10 kHz, in the range of 10 15 kHz, in the range of 15-20 kHz, in the range of 20-30 kHz, in the range of 15-25 kHz, in the range of 10-40 kHz, in the range of 5-45 kHz, or in the range of 15-35 kHz.

Aspect 12. The method of Aspects 10 or 11 wherein the vibrations, twisting, torsion angle, and/or other translation comprise high frequency vibration, twisting or translation above 5 kHz, or above 10 kHz, or above 20 kHz, or above 25 kHz, or above 30 kHz.

Aspect 13. The method of any of Aspects 8-12 wherein the rotating body is rotating at a speed of 5,000 RPM or higher, or a speed of 10,000 RPM or higher, or a speed of 15,000 RPM or higher, or a speed of 18,000 RPM or higher, or a speed of 20,000 RPM or higher, or a speed of 10,000 RPM to 50,000 RPM, or a speed of 12,000 RPM to 45,000 RPM, or a speed of 8,000 RPM to 22,000 RPM, or a speed of 17,000 RPM to 28,000 RPM.

Aspect 14. The method of any of Aspects 10-13 comprising measuring torque indirectly by measuring torsion angle of a shaft of the rotating body.

Aspect 15. The method of any of Aspects 10-14 comprising measuring torque indirectly by measuring average twist along a length of a shaft of the rotating body between the two optical probes.

Aspect 16. The method of any of Aspects 8-15 which employs a variable binning technique wherein each revolution of the rotating body is not subdivided into bins of fixed width (in radians), but a set number of data points are used for comparison.

Aspect 17. The method of any of Aspects 8-16 which is a non-contact measuring technique for measuring torque indirectly and wherein data points are correlated against the initial modal interference pattern to determine any phase change due to rotation and speed of a shaft of the rotating body.

Aspect 18. The method of any of Aspects 8-17 which has a measurement accuracy of better than 2% full-scale and a real-time reporting rate of 5 kHz to 10 kHz to 20 kHz and higher on the rotating body when rotating at speeds of 18,000 RPM or higher.

Aspect 19. The method of any of Aspects 8-18, further comprising accounting for 1 or 2 markers per revolution of the rotating body, or 5 to 15 markers per revolution of the rotating body, or 10 to 20 markers per revolution of the rotating body, or 18 to 25 markers per revolution of the rotating body, or 22 to 30 markers per revolution of the rotating body, or at least 20 markers per revolution of the rotating body, or at least 8 markers per revolution of the rotating body, or at least 10 markers per revolution of the rotating body.

Aspect 20. The method of any of Aspects 8-19 wherein at least 10 or more, 15 or more, or 20 or more unique identifiers are considered along a circumference of the rotating body.

### BRIEF DESCRIPTION OF THE DRAWINGS

The accompanying drawings illustrate certain aspects of embodiments of the present invention, and should not be used to limit the invention. Together with the written description the drawings serve to explain certain principles of the invention.

FIG. 1 is a schematic diagram showing an embodiment of the invention.

FIG. 2A is a schematic diagram showing another embodiment of the invention.

FIG. 2B is a photograph showing optical probe embodiments of the invention.

FIG. 2C is a photograph of an instrumentation embodiment of the invention.

FIG. 3 shows sample measurement waveforms. When a rotating shaft is observed between loaded and no-load conditions, there is a phase shift between the measurement patterns. Using the no-load as the initial reference pattern, the twist of the shaft under load conditions may be made by comparing the change in phase shift. Note that the change is not strictly a unilateral time shift, but the two curves show different delays depending on the time observed—typical of a phase shift between two curves. The inset of the figure shows a closer view of the phase shift of the central peak.

FIG. 4 is a schematic diagram which shows an algorithm for Field Programmable Gate Array (FPGA)-based processing according to an embodiment of the invention.

FIG. 5 is a schematic diagram showing the path of light as it travels from the laser, to the shaft surface, and is reflected back to the optical detector.

### DETAILED DESCRIPTION OF VARIOUS EMBODIMENTS OF THE INVENTION

Reference will now be made in detail to various exemplary embodiments of the invention. It is to be understood that the following discussion of exemplary embodiments is not intended as a limitation on the invention. Rather, the following discussion is provided to give the reader a more detailed understanding of certain aspects and features of the invention.

In one embodiment of the invention, a pair of optical probes are pointed to a rotated body, separated by a gage length. An initial pattern of modal interference resulting from the reflection of the illuminating light by the surface of the rotating body is generated during an initial calibration phase. During operation, a portion of the instantaneous modal interference pattern from up to an entire revolution of the body is collected and compared to the initial interference pattern using a correlation function. The phase difference between the operational and initial interference patterns, coupled with the instantaneous speed measurement, provides a measure of the twist of the shaft with time. The frequency of twist that can be characterized is a function of the size (in time) of the section of the operational pattern used to determine local motion.

In another embodiment, a single optical probe is used to generate an initial and operational modal interference reflection pattern. Comparison of the instantaneous pattern to the initial pattern enables the system to determine the frequency (not direction) of vibratory motion on the rotating body. Often, users are interested only in the mode (i.e. frequency) of vibration of a shaft. Even without the quadrature provided by a second probe, the amplitude and frequency of the vibratory modes may be calculated.

In embodiments, two or more arrays of probes are separated by a gage length. As the rotating body moves in directions other than in a rotary fashion (e.g. thrust of a shaft), the initial interference pattern fingerprint for one probe in an array will shift to a different probe within that array. The shift between correlation from one probe to another provides a measure of the degree of motion of the rotating body in the direction of separation of the two probes. This information can be coupled with the twist information gathered from the two probe arrays to provide rotation speed, vibration vector (amplitude, frequency, and direction), and thrust motion of the rotating body.

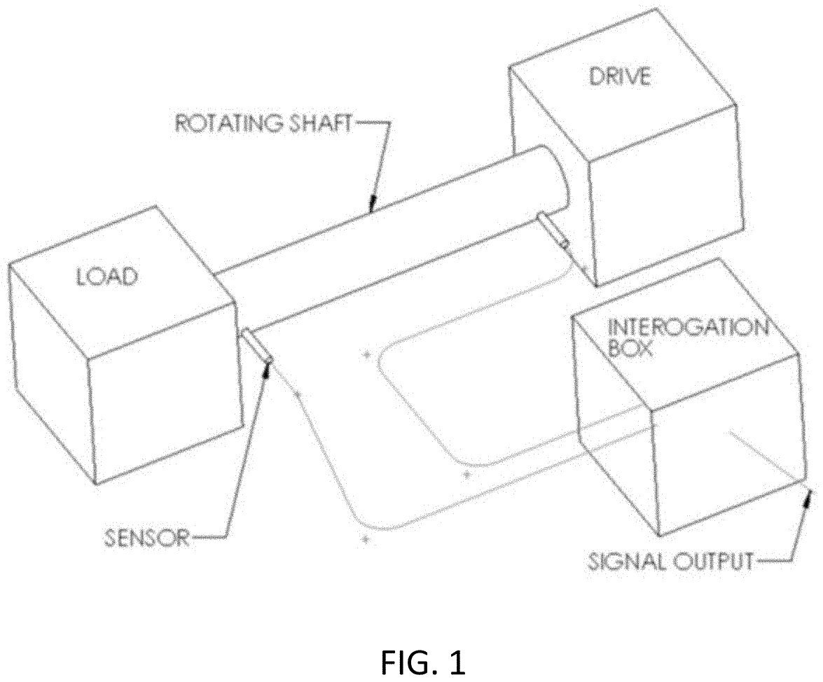

FIG. 1 shows a preferred embodiment of the invention. In the figure, a shaft connects a drive to a load. A pair of sensors are located along the shaft, separated by a known distance. The outputs of the probes are connected to an instrument that compares the outputs of the probes to one another to determine the change in phase between surface patterns. The change in phase is then converted to twist, and the torque is calculated from the geometry of the configuration. The output of the torquemeter may then be fed to any data collection or logging instrumentation.

The present inventors have implemented the system shown in FIG. 1 as a pair of hardened optical probes connected to a compact data acquisition and processing electronics package by way of optical cables. The system measures shaft twist, calculates torque, and provides real-time reporting at 20 kHz data rates. The hardened optical probes include sapphire windows. As described further in the Examples, the compact, rugged instrumentation provides high speed, calibrated torque measurement.

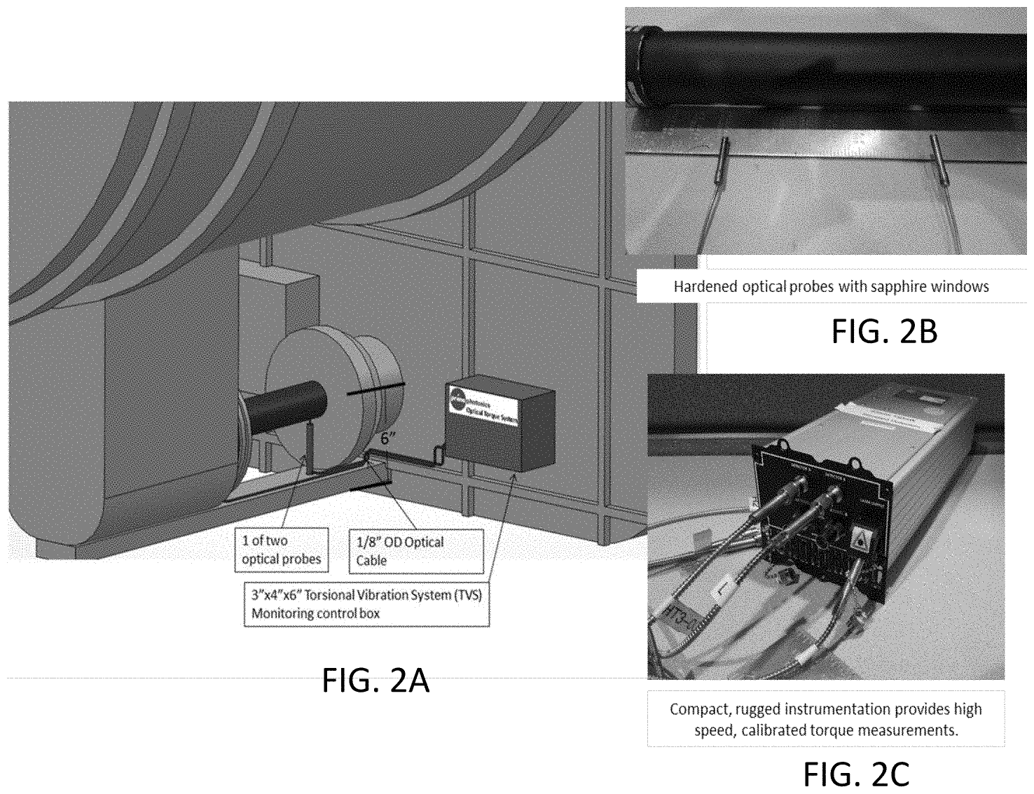

FIGS. 2A-C show another embodiment of the invention comprising a pair of hardened optical probes, and a compact data acquisition and processing electronics package. The system measures shaft twist, calculates torque, and provides real-time reporting at 20 kHz data rates.

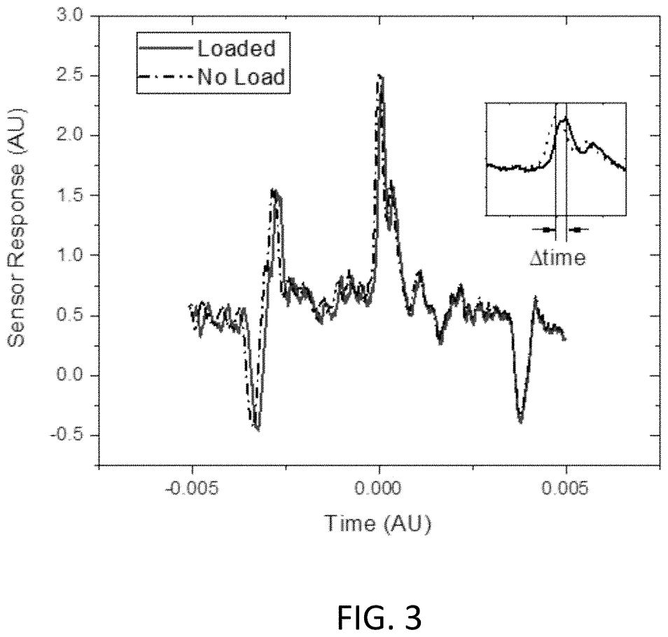

FIG. 3 is a graph showing sample measurement waveforms. When a rotating shaft is observed between loaded and no-load conditions, there is a phase shift between the measurement patterns. Using the no-load as an initial reference pattern, the twist of the shaft under load conditions may be made by comparing the change in phase shift. Note that the change is not strictly a unilateral time shift, but the two curves show different delays depending on the time observed—typical of a phase shift between two curves. The inset of the figure shows a closer view of the phase shift of the central peak.

Embodiments of systems of the invention can include a computing device or instrument that includes a processor (CPU), graphics processing unit (GPU), and non-transitory computer readable storage media such as RAM and a conventional hard drive. Other components of the computing device can include a database stored on the non-transitory computer readable storage media. As used in the context of this specification, a “non-transitory computer-readable medium (or media)” may include any kind of computer memory, including magnetic storage media, optical storage media, nonvolatile memory storage media, and volatile memory. Non-limiting examples of non-transitory computer-readable storage media include floppy disks, magnetic tape, conventional hard disks, CD-ROM, DVD-ROM, BLU-RAY, Flash ROM, memory cards, optical drives, solid state drives, flash drives, erasable programmable read only memory (EPROM), electrically erasable programmable read-only memory (EEPROM), non-volatile ROM, and RAM. The non-transitory computer readable media can include a set of computer-executable instructions, or software for implementing the methods, processes, operations, and algorithms of the invention. The computer-readable instructions can be programmed in any suitable programming language, including JavaScript, C, C #, C++, Java, Python, Perl, Ruby, Swift, Visual Basic, and Objective C.

The non-transitory computer-readable medium or media can comprise one or more computer file(s) comprising a set of the computer-executable instructions for performing the methods, processes, operations, and algorithms of the methods of the invention and optionally an operating system. In exemplary embodiments, the files may be stored contiguously or non-contiguously on the computer-readable medium. Embodiments of the invention may also include a computer program product comprising the computer files, either in the form of the computer-readable medium comprising the computer files and, optionally, made available to a consumer through packaging, or alternatively made available to a consumer through electronic distribution such as downloading from the internet.

Other components of the computing device can include network ports (e.g. Ethernet) or a wireless adapter for connecting to the Internet, input/output ports (e.g. USB, PS/2, COM, LPT), a mouse, a keyboard, a microphone, headphones, a display, and the like. If under control of an operating system, the software programs for implementing the methods of the invention can be accessed via an Application Programming Interface (API), Software Development Kit (SDK) or other framework. In general, the computer-executable instructions for implementing the methods, and/or data, are embodied in or retrievable from the disk space or memory of the device, and instruct the processor to perform the steps of the methods. Input/output ports may be used to connect the computing device to the probes or a data logger.

Additional embodiments may include or be enabled in a networked computer system for carrying out one or more of the methods of this disclosure. The networked computer system may include any of the computing devices described herein connected through a network. The network may use any suitable network protocol, including IP, TCP/IP, UDP, or ICMP, and may be any suitable wired or wireless network including any local area network, wide area network, Internet network, telecommunications network, Wi-Fi enabled network, or Bluetooth enabled network.

The systems and methods of the invention can be applied to any system or apparatus with a rotating body, such as engines, crankshafts, gearboxes, transmissions, rotors, and compressors. Other uses and applications will be apparent to the skilled artisan.

### EXAMPLES

The FOCIS™ hardware was leveraged to develop a non-contact, optical torque measurement system. The system was demonstrated on as-received titanium and carbon fiber shafts, as well as painted titanium and carbon fiber shafts. The system was used to measure torque to a 0.023° accuracy, corresponding to 50 in-lbs at 8 inches on a 2-inch steel shaft. The Phase I hardware used post-processing algorithms that would provide for a reporting rate greater than 9.6 kHz upon translation to a real-time system.

A demonstration of measurement accuracy of better than 2% full-scale and real-time reporting rate of 20 kHz on various shafts rotating at speeds approaching 18,000 rpm can be expected by embodiments of the invention. In embodiments, the invention is expected to provide an impartial validation of the ability to report torque to within 2% full scale accuracy with a reporting rate that exceeds 10 kHz on a shaft rotating at 18,000 rpm.

In addition to monitoring the performance of both motors and associated loads, accurate characterization of shaft torque and vibration provides critical information about fault conditions that can ultimately lead to catastrophic component failure, and provide valuable information about system efficiencies. Existing methods for torque measurement typically function through direct contact with the shaft—most often through attachment of strain gages to the shaft. Current non-contact optical methods require imparting a contrast pattern to the surface of the shaft. Whether through a laser etched blaze pattern, painted features, or the application of zebra tape, these methods require modifications to the shaft, and do not lend themselves to retrofit applications where shaft modifications are unacceptable. There is currently no method for measuring shaft torque without parasitically loading the shaft or incurring significant penalties for installation.

The system of the invention features a pair of shock and vibration hardened, high temperature capable FOCIS™ probes, with the capability to detect native surface features on shafts, wheels, or blades. High-speed, cross-correlation of the spectra of the captured waveforms yields a phase delay that corresponds to twisting of the shaft. An accuracy of 50 in-lb across an 8-inch gage length was previously demonstrated, with a projected reporting rate exceeding 9.6 kHz. The hardware can be configured to consist of a pair of custom-designed, hardened optical probes, and a high-speed laser driver/digitization instrument with a real-time reporting rate of 20 kHz, and an accuracy better than 2% full-scale. Not only can the high-speed system be configured to provide non-contact, highly accurate torque measurements, it can also be configured to measure shaft speed, and high frequency vibrational modes.

According to embodiments, one or more of the optical probe(s) used in the system sends a light signal to the target (shaft) surface and then captures reflected light. The probe(s) can be optical probes with a lens on the end of the probe, or can be a probe where the optical fiber simply ends at the tip of the probe. The lensed configuration allows the probe to be operated a further distance from the shaft. The probes can be configured in a number of ways. For example, the probes can have both input and output channels lensed, providing focused or collimated light on the output channel and collimated or focused acceptance from the input channel. Alternatively, the probes can be unlensed where light from the probe immediately diverges at the exit of the probe output channel with the same for the receive input channel in the probe. Further, a combination of the above is possible, where either the output is lensed and input is unlensed, or the input is lensed and the output is unlensed.

A prototype optical torque measurement system (OTS) has been designed and fabricated and its capability to accurately measure torque twist across varying surface finishes, torque levels, and shaft speeds has been demonstrated. The system can measure twist with a resolution of better than 0.08°, with a data reporting rate of up to 9.6 kHz. The ability to measure twists of up to 6° has been demonstrated, though there is physically no upper bound on the measurement. The system can measure twist on virtually any material including titanium shafts, carbon fiber shafts, painted shafts (either titanium or steel). The twist on shafts with large total indicated runout (TIR) of up to 0.05″ has been demonstrated, which indicates insensitivity to large shaft runouts.

The system can be configured with the ability to measure torque to within 100 in-lb. The nature of the FOCIS™ OTS system measurement technique is such that there is no limit to the torque that can be measured. By correlating the phase shift between any two points on the shaft, the system can measure shaft twists that exceed 360°. The minimum torque measurement is a function of the resolution of the optical sensors (both spatially and temporally), the sensor-to-sensor spacing, and the modulus of the shaft. It is expected that the system can provide adequate resolution to measure torsion angles small enough to attain better than 2% accuracy on a 5000 in-lb full scale load.

The system can also be configured with the ability to report torque at 5 kHz for an 18,000 RPM rotation rate. The second highest technical risk lies in the required reporting rate. To provide a 5 kHz reporting rate, a torsional torque measurement system requires roughly 20 markers per revolution, assuming an 18,000 RPM rotation rate. For this system to operate as a truly non-invasive measurement technique, the ability to identify over 20 unique identifiers along the circumference of the shaft, and perform local cross-correlated phase determination with very high resolution is preferred. It is further preferred that the FOCIS™ OTS system can operate within parameters where the 5 kHz requirement can be exceeded.

The systems can also be configured with algorithms to enable FGPA processing for real-time reporting. The raw output of the system can be configured to comprise a set of voltages corresponding to the local reflectivity of the shaft. Translating these waveforms into usable torque data typically requires several processing steps—including Fourier transforms, filtering, and cross-correlation. The implementation of these algorithms in post-processing is time consuming, and typically requires trained personnel. It is expected that the invention can provide data processing algorithms necessary to supply users with accurate, reliable, and timely information via implementation of data processing into the Prime Photonics FPGA-based FOCIS™ Data Capture Unit. Included are an Assembled Torque Demonstration Rig for titanium and composite shafts, an executed test matrix for variable shaft materials, surface finishes, torques and rotation rates, a twist measurement algorithm, a binning algorithm to support wide range of speed operation, measurement update at 9.6 kHz reporting rate, twist angle resolution better than ±0.09°, system operation with various shaft surface finishes, including bare titanium, carbon fiber, and painted titanium, demonstration of the system on multiple shaft diameters and on shafts with varying rigidity and moment of inertia, and embodiments for Navy, DoD and industrial applications.

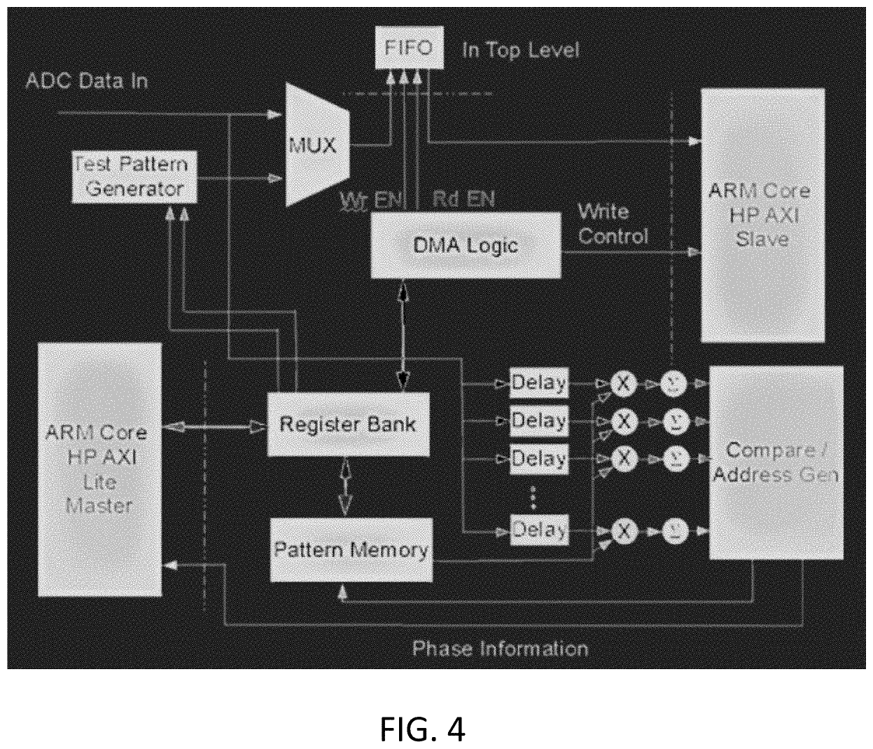

According to embodiments, one or more algorithm(s) for FPGA-based processing are configured as follows. First, the data from the probe is filtered to remove coupled noise, then routed to several parallel delay lines. Each of these delayed versions of the sample data is then multiplied by a previously recorded pattern read from memory, and the resulting products are integrated over a programmable time to calculate points on a correlation curve. The magnitude of these correlation sums is then compared, and the address of the pattern memory is varied in such a fashion as to center the correlation peak. This process is performed continuously, and the resulting address represents the rotating body angle as a function of time. The algorithm (specific to implementation in an FPGA) is shown schematically in FIG. 4. However, as appreciated by a skilled artisan, the one or more algorithm(s) can be implemented in software, alternatively or in addition to hardware implementation.

It is also expected that the system can be configured to meet the needs of the Navy, NAVAIR 4.4.2, PMA 234 and PMA 265.

In previous efforts, the OTS system used a simple, unlensed FOCIS probe. While the unlensed probe is hardened against shock and vibration, and provided an accuracy of better than 100 in-lbs on the test rig, there are potential improvements that can be made to the probe to increase accuracy and decrease sensitivity to vibration and probe placement. Implementation of a simple, spherically lensed probe geometry can provide a collimated detection beam that will remove sensitivity of probe-to-shaft distance, and provide for a higher signal to noise ratio during measurement.

The FOCIS™ system has a standard instrumentation package that consists of a laser driver/optical detection instrument and a PXIe-based FPGA card for data post processing. Typical installations can require as many as 16 channels of laser light and data acquisition. For the OTS system, a typical installation will require only a pair of source/detect channels.

The system can be configured with an instrument for high speed digitization of analog signals. Current digitizer electronics can sample at 125 MS/s, providing more than enough bandwidth to meet the reporting rates required for this project. The hardware also features on-board FPGA and multi-core processors to enable high speed analysis of the data. The existing hardware, however, can be modified to accommodate the torque measurement system, including for example a front end capable of accepting optical signals and converting to electrical signals for the digitizer board.

The system can also be equipped with real-time monitoring software. Previous instruments feature a basic, native GUI to allow for rudimentary control of amplification levels and data processing parameters. The on-board software and GUI can be adapted to enable application-specific parameter control of the front-end amplification and filtering, as well as the data processing algorithms necessary to convert twist measurements into applied torque.

In previous efforts, post-processing algorithms were developed to divide the reflection pattern for each revolution of the shaft into a fixed number of bins. While this calculation method has the potential to provide data reporting rates in excess of 20 kHz, new algorithms have been formulated to provide a higher degree of quality in the correlated signal while maintaining the high data rate. The algorithm involves a variable binning technique wherein each revolution of the shaft is not subdivided into bins of fixed width (in radians), but a set number of data points are used for comparison. The data points are correlated against the entire initial shaft pattern, or a portion thereof, to determine the phase change due to rotation, as well as the current speed of the shaft. The data are continually updated in a first-in/first-out technique, providing a moving pattern matching algorithm throughout the shaft rotation. As such, the software can be configured to comprise algorithms to correlate partial fingerprint patterns with the calibrated previously recorded pattern, and to automatically update the previously recorded pattern to accommodate for changes in the reflected interference pattern from the shaft surface.

The initial modal interference pattern against which measurements are compared can also be updated. During regular operation of the torque monitor system, the expectation is that the shaft will undergo changes—whether through scratches to the surface, or through deposition of surface contaminants (dust, oil, grease). To account for small changes in the optical properties of the shaft, the software must update the previously recorded pattern to include evolution to the shaft. The principal difficulty and risk inherent in this update algorithm will be to ensure that higher order harmonic vibrations are not filtered out through an incorporation into the previously recorded pattern.

Algorithms can also be drafted and translated to the software on the instrument being used. Verification of the algorithms should not only involve validation of the language of the code, but also of the operation of the algorithms themselves. Validation of the algorithms is somewhat agnostic of shaft rotation conditions (in terms of speed and applied torque), and can therefore be validated using the test rigs. The algorithms can also be further stress tested by exploring the effects of shaft rotational parameters on reporting rate and torque accuracy.

Additional tests can be used to focus on normalization of the system against mean strain and higher frequency strain. High frequency transients during shaft spin-up and ramp-down periods have been identified as characterization targets. Current torque measurement systems have difficulty tracking higher order harmonics during rapid acceleration, and one objective is to capitalize on the high reporting rate available from the system to capture these dynamics.

The FOCIS™ Optical Torque Sensor (FOCIS™ OTS) optically measures small changes in shaft torsion without contacting the shaft and without any modifications to the shaft material or finish, providing a robust solution for non-contact torque measurements on rotating shafts that is particularly well-suited for retrofit applications. The high frequency response of FOCIS™ OTS also makes it ideal for shaft torsional vibration measurements, an important consideration for shaft driven systems that have rapidly varying load characteristics. The retrofittable capability of FOCIS™ OTS will enable shaft torque and torsional vibration measurements to be made on a wide range of engines and equipment for diagnostics and test and evaluation, and will create new design opportunities for future aircraft, industrial and commercial equipment designs.

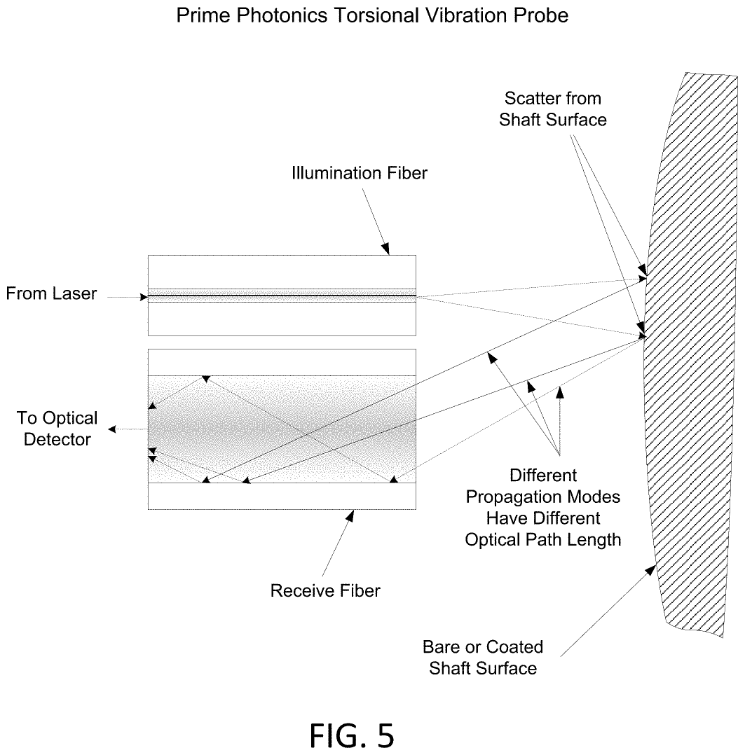

Torsional monitoring systems according to embodiments of the invention make use of interference between propagation modes in a multi-mode optical fiber. Light from a laser is guided by an optical to the tip of the probe from where is illuminates the surface of a rotating body (FIG. 5). This fiber may be single or multi-mode. A portion of the light reflected from the rotating body is captured by one or more multi-mode optical fiber(s) and guided to an optical detector. Rays entering the receiver fiber at different angles form different propagation modes in the fiber, and as such travel different distances. The different modes interfere, resulting in a modulation of the optical intensity at the detector. As the body rotates, the fraction of the reflected light that enters any given mode changes. This is due to any or all of four different mechanisms.

1) Different facets of the surface reflect light in different directions, into different propagation modes.

2) If the surface is coated, variations in the surface of the coating result in different angles of refraction of the reflected light.

3) Variations in the coating thickness will change the optical path length as a function of angle.

4) Variations in the distance from the probe to the shaft surface will change the optical path length.

The resulting variation in differential optical path lengths seen by the different propagation modes produce the variation in optical intensity.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

The present invention has been described with reference to particular embodiments having various features. In light of the disclosure provided above, it will be apparent to those skilled in the art that various modifications and variations can be made in the practice of the present invention without departing from the scope or spirit of the invention. One skilled in the art will recognize that the disclosed features may be used singularly, in any combination, or omitted based on the requirements and specifications of a given application or design. When an embodiment refers to “comprising” certain features, it is to be understood that the embodiments can alternatively “consist of” or “consist essentially of” any one or more of the features. Other embodiments of the invention will be apparent to those skilled in the art from consideration of the specification and practice of the invention.

1. A method for the characterization of motion of a rotating body comprising:
measuring at least one modal interference pattern of light reflected from a surface of a rotating body at two or more points in time; and
comparing at least a portion of the measured modal interference patterns to determine a change in motion of the rotating body between those two points in time.

2. The method of claim 1, wherein only a single measurement point on the rotating body is used to determine rotation speed of the rotating body.

3. The method of claim 1, wherein a single measurement point on the rotating body is used to determine the amplitude and/or frequency of angular vibration of the body.

4. The method of claim 1, wherein multiple measurement points on the rotating body are used to determine any twist on the body.

5. The method of claim 4, wherein multiple measurement points on the body are used to determine the twist on the body in order to calculate any torque applied to the body.

6. The method of claim 1, wherein multiple measurement points on the body are used to determine motion on the body that is coherent between multiple measurement points in order to mitigate effects of vibration of the body that is not angular.

7. The method of claim 1, wherein multiple measurement points on the body are used to determine motion on a body that is axial in nature.

8. A method for the characterization of motion of a rotating body, comprising:
using at least one optical probe, measuring at least one modal interference pattern resulting from reflection of illuminating light by a surface of a rotating body to provide an initial modal interference pattern therefrom;
using at least one optical probe, measuring at least one operational modal interference pattern resulting from reflection of illuminating light by the surface of the rotating body; and
comparing the operational modal interference pattern to the initial modal interference pattern using a correlation function, thereby determining a phase difference between the operational modal interference pattern and the initial modal interference pattern to provide a measure of any twist of the rotating body with time.

9. The method of claim 8, wherein the modal interference pattern and/or the operational modal interference pattern is measured using two optical probes.

10. The method of claim 8, which is a non-contact measuring technique for measuring one or more of vibrations, twisting, torsion angle, and/or other translation of the rotating body.

11. The method of claim 10, wherein the vibrations, twisting, torsion angle, and/or other translation have a frequency in the range of 1-5 kHz, in the range of 5-10 kHz, in the range of 10-15 kHz, in the range of 15-20 kHz, in the range of 20-30 kHz, in the range of 15-25 kHz, in the range of 10-40 kHz, in the range of 5-45 kHz, or in the range of 15-35 kHz.

12. The method of claim 10, wherein the vibrations, twisting, torsion angle, and/or other translation comprise high frequency vibration, twisting or translation above 5 kHz, or above 10 kHz, or above 20 kHz, or above 25 kHz, or above 30 kHz.

13. The method of claim 8, wherein the rotating body is rotating at a speed of 5,000 RPM or higher, or a speed of 10,000 RPM or higher, or a speed of 15,000 RPM or higher, or a speed of 18,000 RPM or higher, or a speed of 20,000 RPM or higher, or a speed of 10,000 RPM to 50,000 RPM, or a speed of 12,000 RPM to 45,000 RPM, or a speed of 8,000 RPM to 22,000 RPM, or a speed of 17,000 RPM to 28,000 RPM.

14. The method of claim 8, comprising measuring torque indirectly by measuring torsion angle of a shaft of the rotating body.

15. The method of claim 9, comprising measuring torque indirectly by measuring average twist along a length of a shaft of the rotating body between the two optical probes.

16. The method of claim 9, which employs a variable binning technique wherein each revolution of the rotating body is not subdivided into bins of fixed width (in radians), but a set number of data points are used for comparison.

17. The method of claim 8, which is a non-contact measuring technique for measuring torque indirectly and wherein data points are correlated against the initial modal interference pattern to determine any phase change due to rotation and speed of a shaft of the rotating body.

18. The method of claim 8, which has a measurement accuracy of better than 2% full-scale and a real-time reporting rate of 5 kHz to 10 kHz to 20 kHz and higher on the rotating body when rotating at speeds of 18,000 RPM or higher.

19. The method of claim 8, further comprising accounting for 1 or 2 markers per revolution of the rotating body, or 5 to 15 markers per revolution of the rotating body, or 10 to 20 markers per revolution of the rotating body, or 18 to 25 markers per revolution of the rotating body, or 22 to 30 markers per revolution of the rotating body, or at least 20 markers per revolution of the rotating body, or at least 8 markers per revolution of the rotating body, or at least 10 markers per revolution of the rotating body.

20. The method of claim 19, wherein at least 10 or more, 15 or more, or 20 or more unique identifiers are considered along a circumference of the rotating body.
